(19) United States
(12) Patent Application Publication
(10) Pub. No.: US 2025/0285501 A1
(43) Pub. Date: Sep. 11, 2025

(54) Fraud Prevention in Location-Specific Game of Chance Ticket Redemption

(71) Applicants: Stanislav Konrath, Milwaukee, WI (US); Christopher Trudeau, Milwaukee, WI (US); Robert Deiss, Milwaukee, WI (US)

(72) Inventors: Stanislav Konrath, Milwaukee, WI (US); Christopher Trudeau, Milwaukee, WI (US); Robert Deiss, Milwaukee, WI (US)

(21) Appl. No.: 19/070,143

(22) Filed: Mar. 4, 2025

Related U.S. Application Data
(60) Provisional application No. 63/561,482, filed on Mar. 5, 2024.

(51) Int. Cl. G07F 17/32; B65B 61/02; G06K 19/06; G06Q 30/018

(52) U.S. Cl. CPC G07F 17/3241; B65B 61/025; G06Q 30/0185; G07F 17/3246; G07F 17/3253; G06K 19/06037

(57) ABSTRACT

Location specific game of chance promotional game pieces are sold to promoters in a pack marked with a unique identifier. The promoter enters this unique identifier into a local computer within a local redemption terminal. The terminal queries a remote computer maintained by the pack's supplier and if the unique identifier corresponds with a pack originating with the supplier, pack-specific prize information is downloaded to the redemption terminal and stored locally. When the owner of a game piece scans a game piece at the redemption terminal, its unique code is compared against the local list of winners to confirm that it is a valid prize which has not previously been redeemed, and then cash is dispensed to the owner.

### CROSS REFERENCES TO RELATED APPLICATIONS

This application claims the benefit of priority of U.S. Provisional App. No. 63/561,482, filed Mar. 5, 2024, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to location-specific games of chance promotions and sweepstakes in general and to systems for tracking and awarding prizes for such promotions in particular.

Gaming activities with awarded prizes are regulated by most states. In-pack chance promotions are promotional games, wherein a player receives a playing card or playing ticket (game piece) that gives the player an opportunity to win an instant prize. The in-pack chance promotion differs from a lottery by the game piece itself having a value component, either through a coupon on the game piece for other goods or through inherently having value such as being a collectible item. In-pack chance promotions further differ from a lottery game where there is a defined winner and a defined loser. The instant win portion of the game serves as a promotional incentive to encourage purchasing or obtaining of the game pieces. Although game pieces are usually purchased, regulations require that a game piece must be provided at no charge to those who request one, for example by writing in to the promoter and requesting a game piece. Finally, the in-pack chance promotion has a defined end-date, clearly states the odds of winning, and generally the game promoter is required to keep track of personal information of winners of prizes over a certain amount.

One of the more common types of location specific gaming tickets is the in-pack chance promotion pull-tab ticket or card. The pull-tabs are generally made of heavy paper or cardboard, and have one or more rows of symbols that are covered by a tab having a perforated perimeter. The pull-tabs are generally sold in boxes or “packs” of several thousand tickets to locations that desire to run the promotion and sell the tickets. Players receive a ticket, either purchased at the participating location directly from staff or from a vending machine, or by writing in to the promoter. The player pulls back the covering tab to reveal the markings which indicate whether a prize has been won. If the symbols reveal a certain winning pattern, as defined elsewhere on the ticket, the player can redeem a prize, usually a cash amount. When redemption of the instant win prize is handled by staff on site at locations where the game pieces are sold, the winning player may then choose how to realize the value component aspect of the ticket, possibly by saving it as a collectible, or using the coupon on it to save money on the goods that are offered.

On-site redemption of the instant win part of the ticket by staff requires that cash must be kept on-site, introducing security risks and opportunities for employee theft. It also occasions frequent inefficiency, where a customer purchases a ticket, instantly wins a prize of $1, and wants to cash it in to buy another ticket. This is a frequent annoyance for staff, who are generally busy doing other things, a common example being a bartender. There is also potential for fraud with the current system wherein a player can cash in a ticket with staff that was not sold on premises, which has been modified to show a higher instant win value, or has already been paid elsewhere. Game pieces sold off-site must not be redeemed, as the prizes are funded by individual proprietors.

What is needed is a system permitting automatic redemption of game pieces which protects against fraud and the redemption of off-site game pieces.

### SUMMARY OF THE INVENTION

Game pieces are sold to promoters in a pack marked with a unique identifier. The promoter enters this unique identifier into a local computer within a local redemption terminal. The terminal queries a remote computer maintained by the pack's supplier. If the remote computer finds that the prize information for the particular pack associated with the unique identifier has not been previously downloaded, the pack-specific prize information is downloaded to the redemption terminal, enabling the pack's game pieces for cash payout at the redemption terminal. Once the data has been downloaded it is blocked from future attempts to download it, thereby interfering with some types of fraudulent submission of game pieces. Because the prizes awarded for the game pieces within a particular pack are funded only by the promoter who purchased the pack, there are various avenues available for fraud or abuse of the system by unscrupulous operators or employees of operators. This system of this invention guarantees that prize-winning data can be obtained only once, thus countering fraudulent attempts by an employee of an operator of the gaming environment to load prize data on several machines to allow a gaming ticket to be redeemed at several locations one after the other, and countering fraud by a person with access to downloaded prize data creating counterfeit game pieces with codes for redemption at the automatic redemption terminal.

It is an object of the present invention to provide an arrangement which restricts the redemption of game pieces to those pieces from a particular pack.

It is a further object of the present invention to provide a system which facilitates automated redemption of location specific prize-winning game pieces which counteracts fraud.

Further objects, features and advantages of the invention will be apparent from the following detailed description when taken in conjunction with the accompanying drawings.

### BRIEF DESCRIPTION OF THE DRAWINGS

FIG. 1 is a top plan view of a pull-tab ticket game piece of the present invention prior to being played.

FIG. 2 is a perspective view of a player opening up the pull-tab ticket of FIG. 1.

FIG. 3 is a top plan view of an opened pull-tab ticket that does not have an instant winner.

FIG. 4 is a top plan view of an opened pull-tab ticket that does have an instant winner.

FIG. 5 is a perspective view of a game piece vending machine including a scanning device of the present invention.

FIG. 6 is a flow chart showing the process for obtaining, playing and redeeming the game pieces of the present invention.

FIG. 7 is a perspective view of an automatic pay station including a scanning device used in the present invention.

FIG. 8 is a rear elevational view of the game piece of FIG. 1 showing a value component involving a coupon for goods elsewhere, with other game info, text, prize info, and artwork.

FIG. 9 is a rear elevational view of an alternative game piece of this invention, having a value component in the form of a cut-out collectible pog with other game info, text, prize info, and artwork.

FIG. 10 is an isometric view of a pack of game pieces being scanned at a redemption terminal.

FIG. 11 is a flow chart showing the process of loading pack-specific prize information into a redemption terminal.

### DESCRIPTION OF THE PREFERRED EMBODIMENTS

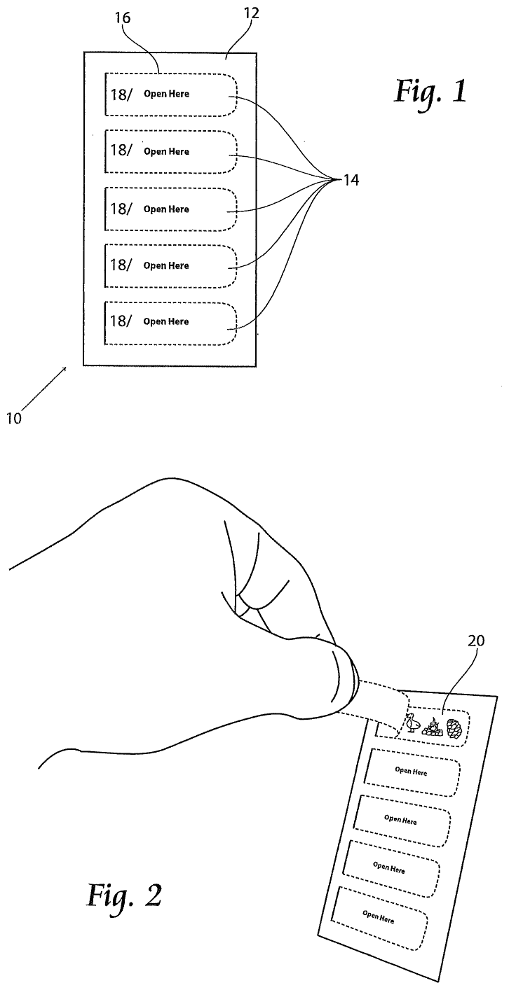

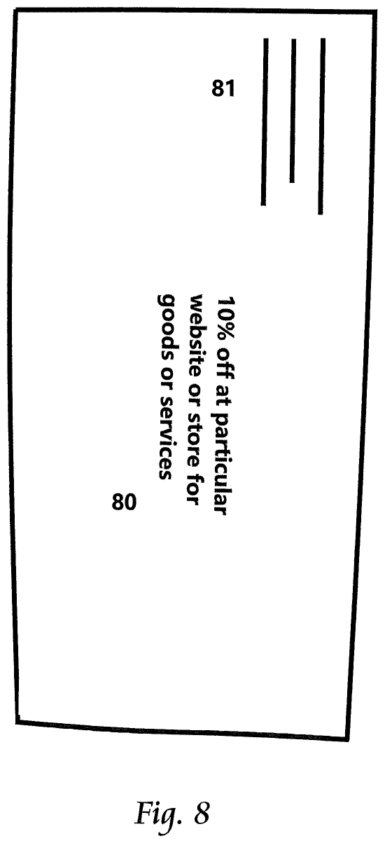

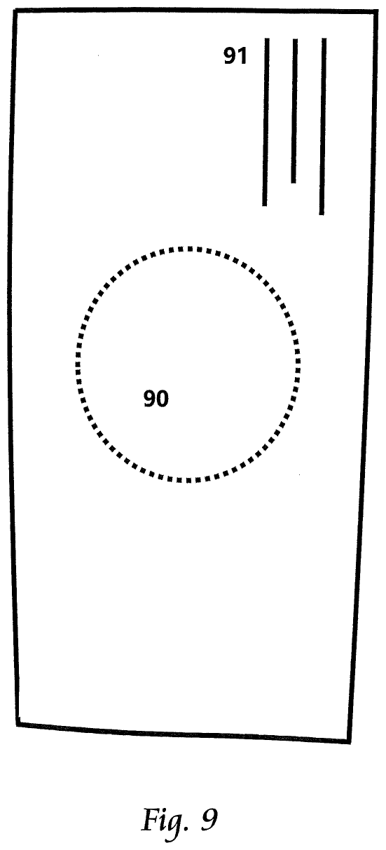

Referring more particularly to FIGS. 1-11, wherein like numbers refer to similar parts, as shown in FIGS. 1-3, a pull-tab ticket or game piece 10 for an in-pack chance promotional game has a paper or card substrate 11 with a perforated top layer 13. The game piece 10 has a game side 12. The top layer 13 is perforated to define a plurality of tabs 18 within slots 14 with a perforated edge 16 which preferably surrounds each tab on three sides. The slots 14 are generally in a rectangular or near-rectangular shape.

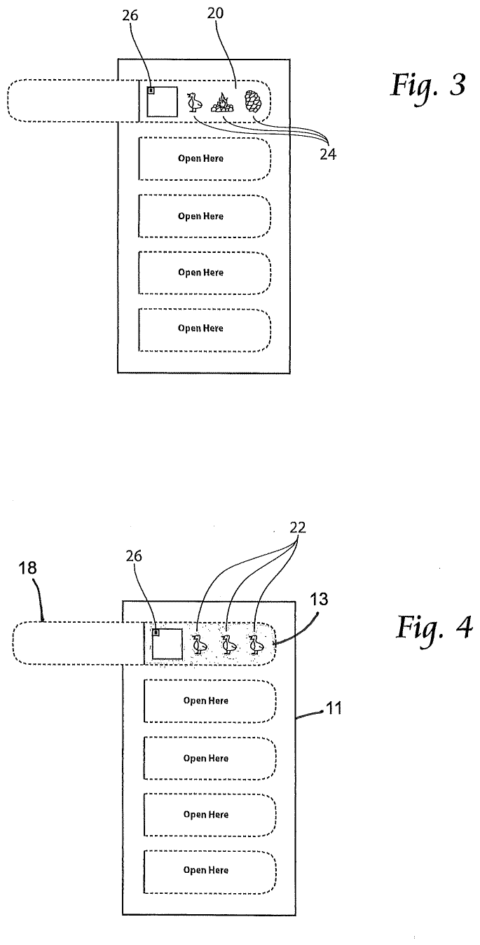

Once the pull tab ticket 10 is purchased, the player will grab the ticket 10 and pull the tab 18 along the perforated edge 16 as shown in FIG. 2. There may be one or more tabs 18 on the ticket 10. Once the tab 18 is pulled back, a window 20 is revealed underneath each of the tabs 18, showing an instant winning combination 22 (FIG. 4) or a losing combination 24 (FIG. 3). A typical winning combination may occur when all of the symbols in a window are the same symbol; however, there may be winning combinations that extend over more than one window, such as a winning symbol required in each window in a diagonal pattern. The associated prize may then be redeemed.

The purpose of the tab 18 is to obscure the window 20 until the game piece is acquired by an individual and the window is revealed. The game piece 10 may be provided with various types of surface obscurement that will hide the underlying window 20 from the player until the surface obscurement is removed. Other types of surface obscurements include scratch-off materials, e.g. foil or ultraviolet (UV) ink, used on game cards, or a beverage bottle that would prevent a person from viewing a prize located on the inside of a bottle cap.

As shown in FIGS. 2 and 3, one of the windows 20 on the ticket 10 will include a computer readable code, e.g. a QR code (quick response code) 26, which can be used by a player to determine whether the ticket is an instant winner. If the ticket 10 has the QR Code located underneath one of the tabs 18, that ticket 10 could be considered a winning ticket. It may also be that all tickets in a particular location-specific game of chance have a QR code located on the ticket 10, and the QR code will assist the player in confirming whether or not the ticket 10 was an instant winner.

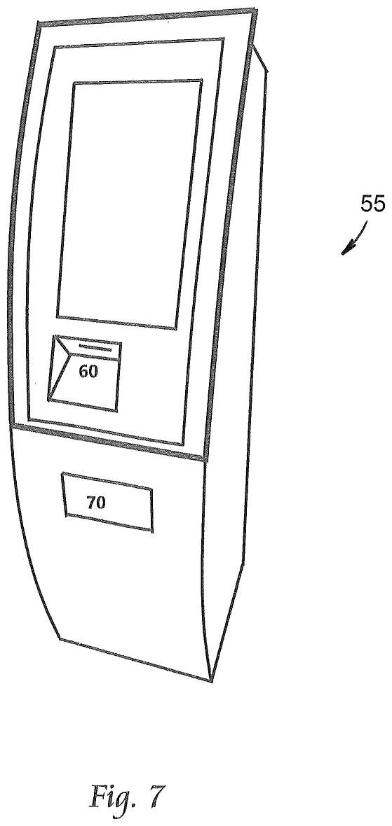

The QR code 26 encourages the user to scan it using a scanning device at a redemption terminal 55 which may be a stand-alone machine, such as an automatic pay station as shown in FIG. 7.

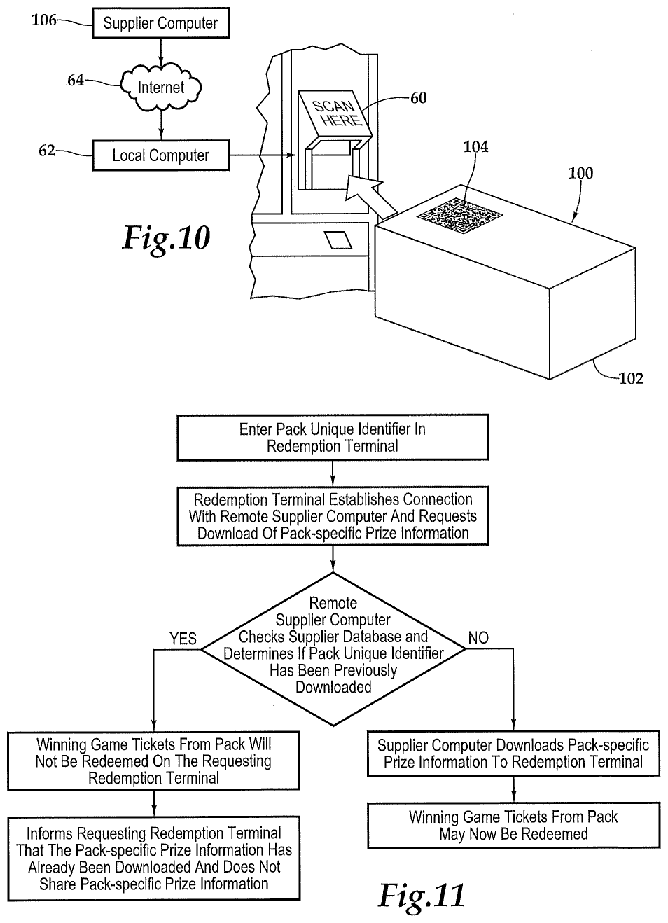

Game pieces 10 are generally sold to game promoters by the supplier in packs 100. As shown in FIG. 10, a common pack 100 is a paperboard carton 102 which is a box containing 4,000 unique game pieces. Winning game pieces 10 are each marked with a unique machine-readable code which enables the redemption terminal 55 to determine the amount of the prize. The actual identifying number of the pack may be encrypted within the machine-readable code. The supplier assembles a computer file listing the prize value associated with each game piece's unique machine-readable code. This file makes up the pack-specific prize information for a particular pack 100 and is stored by the supplier on its remote computer 106 which acts as a file server connected to the internet 64. The supplier packages the game pieces 10 for a particular pack 100 in a carton 102 and marks it with a unique identifier 104 which is a machine-readable mark such as a bar code or a QR code. The pack 100 is transferred to a purchasing promoter's site, such as by shipping in a conventional manner, but the pack-specific prize information is retained on the supplier's server until it is requested by a redemption terminal 55 on the promoter's premises. A database is maintained by the supplier containing each pack, its unique identifier, and whether it has been downloaded to a redemption terminal. The supplier thus makes an entry for the unique identifier associated with the particular pack in the supplier database before the pack is received by the promoter.

When the promoter receives the pack 100 on its premises, the game pieces 10 cannot be released to players until the on-site redemption terminal 55 is able to recognize the winning game pieces. Because all the prizes for a particular pack are paid out by the promoter, it is critical that only prizes from game pieces sold by that promoter be capable of redemption on its premises. To enable the secure redemption of winning game pieces from a pack 100 only at the location at which the game pieces are being sold, winning prize data must be communicated to the local computer in the redemption terminal 55 and nowhere else. The redemption terminal 55 has a scanner 60 which is connected to a local computer 62 which is connectable to the internet 64. Alternatively, the local computer may have a keypad or other device for entering of the unique identifier on the pack 100. As shown in FIG. 10, the pack 100 may be held up to the redemption terminal 55 allowing the unique identifier of the pack to be read. As shown in the flowchart of FIG. 11, once the promoter has scanned or input the unique identifier, the local computer 62 establishes electronic communication with the supplier's remote computer apparatus 106 and requests download of the pack-specific prize data associated with the unique identifier of the particular pack. The remote computer checks whether the unique identifier of the pack for which prize data is being requested corresponds with a pack originating with the supplier. The supplier computer contains prize data for the packs which the supplier has assembled and transferred to customers. Upon receiving the request from the redemption terminal the supplier computer accesses the particular prize data. Moreover, the supplier computer 106 maintains a database of packs for which the prize data has been downloaded. Before responding to the download request, the supplier computer checks the supplier database and determines if pack-specific prize information associated with the unique identifier has been previously downloaded from the supplier computer. If the pack-specific prize information associated with the unique identifier has not been previously downloaded from the supplier computer, then pack-specific prize information associated with the unique identifier is downloaded to the requesting redemption terminal, thereby enabling redemption of prize-winning game pieces from the particular pack of game pieces. The redemption terminal 55 has a pay slot 70 through which cash is dispensed to winners.

If the pack-specific prize information associated with the unique identifier is determined to have been previously downloaded from the supplier computer, then the supplier computer declines to download the pack-specific prize information associated with the unique identifier to the requesting redemption terminal.

Thus, with the unique identifier found to be valid and not a duplicate, the remote computer apparatus sends all of the unique winning codes and their corresponding prize values to the local computer, where the pack-specific prize information is stored locally on the redemption terminal. This prize information includes which of the game pieces of a particular pack is a prize winner, as well as the amounts of each prize. The remote computer then flags this data as already downloaded and will block future attempts to download it.

A duplicate request for pack-specific prize information is an indication of potentially fraudulent activity. The supplier's staff can be notified by the supplier's computer 106 thereby enabling staff to reach out to the declined promoter and to initiate an investigation into the location at which the pack-specific prize information was previously downloaded.

This arrangement provides an important safeguard against fraud which is inherent in a game system involving location-specific gaming tickets. There are several avenues for fraud or abuse of the system by unscrupulous operators or employees of operators. The arrangement of this invention guarantees that the data can be obtained once and only once. If an unscrupulous employee of a promoter of games of chance were able to load prize data on several machines, a game piece could be redeemed at several locations or terminals one after the other, allowing an employee to defraud the employer/promoter. Alternatively, a person with access to the prize data, by identifying the winning game piece information, could create counterfeit QR codes for redemption at the automatic redemption terminal, thus fraudulently obtaining prizes.

An example of a fraudulent situation addressed by the invention: Winner data has already been safely downloaded to the automatic redemption terminal and the data on the remote server has been flagged as “already downloaded”. An unscrupulous actor with access to the unique identifier on the pack attempts to download the prize data to make false redemption tickets. The remote server receives the request, notices the data has already been downloaded, and rejects the request.

The supplier's remote server will look for an authorized redemption terminal ID before downloading data to a requestor, but an unscrupulous actor, such as an employee of the promoter, may have the ability to access an authorized terminal and determine the terminal ID. If an unscrupulous actor with access to the unique identifier on the pack successfully deceives the remote computer and requests a download of prize data (in order to facilitate making false redemption tickets), the supplier's remote server will receive the request, see that the data has not been flagged as downloaded, and will send the winner data. The unscrupulous person then, in the course of normal job duties, attempts to activate the same unique identifier on an automatic redemption terminal. The local computer of the redemption terminal contacts the remote server for the prize data. The remote server sees that it has already been downloaded and rejects the request. Any false game pieces are rendered worthless, because the promoter's redemption terminal will not recognize them.

It should be noted that the pack-specific prize information is retained on the redemption terminal's local computer 62. Hence, even if the location should lose its internet connection, owners of the game pieces can receive their prizes from the redemption terminal. The redemption terminal 55 operates by allowing the owner of a prize-winning game piece 10 to scan the QR code directly at the redemption terminal without the intervention of any other person, and to receive a cash prize from the terminal.

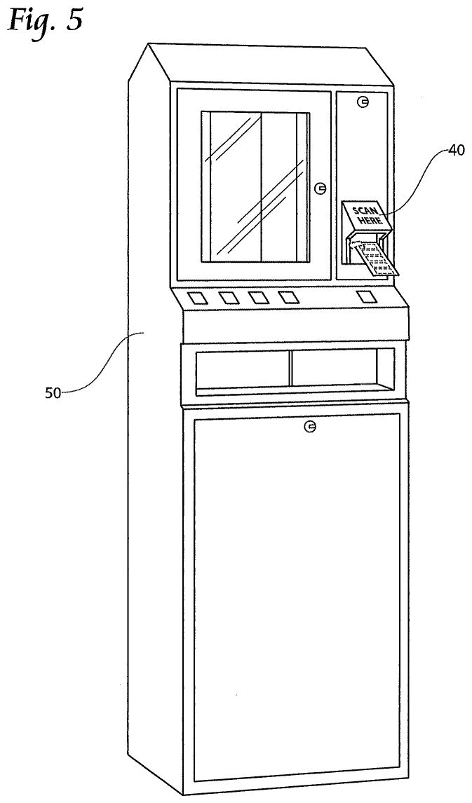

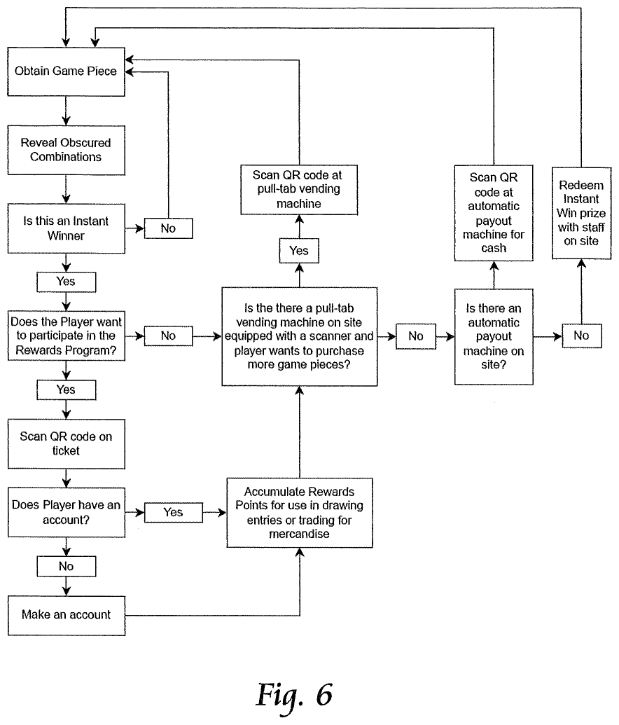

This arrangement improves the efficiency of the location-specific game of chance promotion for the proprietor. A general flow chart of the operation is shown in FIG. 6. The player purchases or otherwise acquires the ticket 10, typically from a dispensing machine 50 as shown in FIG. 5, although it could be directly from a vendor or by procuring one directly from the promoter. The player then pulls the tabs 18 to reveal the windows 20 to thereby determine if the ticket 10 is an instant winner with a QR Code 26.

The invention will allow the gaming ecosystem described above to mitigate many of the issues that currently exist. The QR Code 26 allows for players to redeem any instant win game pieces conveniently at a redemption terminal thereby avoiding human error with on-site staff having to process the winning game pieces. The QR Code 26 also prevents fraud by only allowing tickets that were sold on-site to be redeemed on-site. When the player who is the owner of a game piece presents it at the redemption terminal, the terminal's scanner 60 detects the presented game piece 10 and determines that the game piece is one of the prize-winning game pieces by checking the downloaded pack-specific game information which is stored on the local computer 62, and comparing the detected unique code of the presented game piece against the locally stored pack-specific prize information, and, upon determining that the unique code of the presented game piece is a prize-winner which has not been previously redeemed at the redemption terminal, the redemption terminal dispenses cash to the winner in an amount indicated by the locally stored pack-specific prize information.

Use of the QR code will also limit potential fraud associated with the tickets, as use of the QR code can further verify that a ticket had a particular winning amount.

It is understood that the invention is not limited to the particular construction and arrangement of parts herein illustrated and described, but embraces all such modified forms thereof as come within the scope of the following claims.

1. A method for preventing fraud in a location-specific game of chance involving packs of game pieces originating with a supplier, each of which has a unique code associated therewith, the method comprising:
entering a unique identifier associated with a particular pack of game pieces into a redemption terminal;
establishing electronic communication between the redemption terminal and a remote computer and requesting download of pack-specific prize information from the remote computer for the particular pack of game pieces;
downloading the pack-specific prize information to the redemption terminal and storing the pack-specific prize information locally on the redemption terminal, wherein the pack-specific prize information includes which of the game pieces of the particular pack is a prize winner; and
detecting the unique code of a presented game piece at the redemption terminal and comparing the detected code against the locally stored pack-specific prize information, and, upon determining that the unique code of the presented game piece is a prize-winner which has not been previously redeemed at the redemption terminal, dispensing cash in an amount indicated by the locally stored pack-specific prize information from the redemption terminal.

2. The method of claim 1 wherein the step of establishing electronic communication between the redemption terminal and the remote computer comprises establishing an internet connection.

3. A method for preventing fraud in the redemption of location-specific game of chance game pieces comprising:
entering a unique identifier associated with a particular pack of game pieces into a redemption terminal;
establishing electronic communication between the redemption terminal and a remote supplier computer and requesting download of pack-specific prize information from the supplier computer for the particular pack of game pieces;
on the supplier computer checking a supplier database and determining if pack-specific prize information associated with the unique identifier has been previously downloaded from the supplier computer;
if the pack-specific prize information associated with the unique identifier has not been previously downloaded from the supplier computer, then downloading pack-specific prize information associated with the unique identifier to the redemption terminal thereby enabling redemption of prize-winning game pieces from the particular pack of game pieces; and
if the pack-specific prize information associated with the unique identifier has been previously downloaded from the supplier computer, then declining to download the pack-specific prize information associated with the unique identifier to the requesting redemption terminal.

4. The method of claim 3, further comprising the steps of manufacturing the particular pack of game pieces by:
marking a plurality of game pieces with unique computer-readable markings indicating certain ones of the plurality of game pieces as being prize winners;
obscuring the unique computer-readable markings on the plurality of game pieces;
packaging the marked plurality of game pieces within the particular pack;
physically associating the unique identifier with the particular pack;
recording the unique computer-readable markings associated with prize winners as the pack-specific prize information in the supplier computer and making an entry for the unique identifier associated with the particular pack in the supplier database.

5. The method of claim 4 wherein the step of physically associating the unique identifier with the particular pack comprises the step of marking an exterior of the pack with a machine-readable marking including the unique identifier.

6. The method of claim 5 wherein the unique identifier is encrypted within the machine-readable marking.

7. The method of claim 3 wherein the step of establishing electronic communication between the redemption terminal and a remote supplier computer comprises establishing an internet connection.

8. The method of claim 3 further comprising the step of redeeming a first game piece of the particular pack of game pieces presented at the redemption terminal by reading a computer readable marking on the first game piece, comparing the computer readable marking to the downloaded pack-specific prize information associated with the unique identifier, determining that the first game piece is a winning game piece, and dispensing payment from the redemption terminal.

9. The method of claim 6 wherein the payment dispensed comprises cash.

10. The method of claim 6 wherein the payment dispensed is at least one additional game piece.

11. The method of claim 6 wherein the payment is dispensed directly to an owner of the first game piece without the intervention of any other person.

12. A method for preventing fraud in the redemption of location-specific game of chance game pieces comprising:
marking a plurality of game pieces with unique marks and packaging the plurality of game pieces in a particular pack which is marked with a unique identifier;
associating the unique marks for the plurality of game pieces with prize information and storing the prize information and associated unique marks in a file containing pack specific prize information on a supplier computer;
transferring the pack to a promoter's site which is remote from the supplier computer;
at the promoter's site entering the unique identifier associated with the particular pack of game pieces into a redemption terminal;
establishing electronic communication between the redemption terminal and the remote supplier computer and requesting download of the pack-specific prize information from the supplier computer for the particular pack of game pieces;
on the supplier computer checking a supplier database and determining if pack-specific prize information associated with the unique identifier has been previously downloaded from the supplier computer;
if the pack-specific prize information associated with the unique identifier has not been previously downloaded from the supplier computer, then downloading pack-specific prize information associated with the unique identifier to the redemption terminal thereby enabling redemption of prize-winning game pieces from the particular pack of game pieces;
if the pack-specific prize information associated with the unique identifier has been previously downloaded from the supplier computer, then declining to download the pack-specific prize information associated with the unique identifier to the requesting redemption terminal;
detecting a one of the plurality of game pieces presented at the redemption terminal and determining that the one of the plurality of game pieces is one of the prize-winning game pieces by checking the downloaded pack-specific game information; and
dispensing cash from the redemption terminal.
